(19) United States
(12) Patent Application Publication
(10) Pub. No.: US 2016/0042874 A1
(43) Pub. Date: Feb. 11, 2016

(54) DYE SENSITIZED SOLAR TEXTILES AND METHOD OF MANUFACTURING THE SAME

(71) Applicant: INDUSTRY-ACADEMIC COOPERATION FOUNDATION, YONSEI UNIVERSITY, Seoul (KR)

(72) Inventors: Eun Ae KIM, Seoul (KR); Jong Hak Kim, Seoul (KR); Youngjin Chae, Seoul (KR)

(73) Assignee: INDUSTRY-ACADEMIC COOPERATION FOUNDATION, YONSEI UNIVERSITY, Seoul (KR)

(21) Appl. No.: 14/790,554

(22) Filed: Jul. 2, 2015

(30) Foreign Application Priority Data
Jul. 3, 2014 (KR) 10-2014-0082970

(51) Int. Cl. H01G 9/20

(52) U.S. Cl. CPC H01G 9/2022; H01G 9/2031; H01G 9/204; H01G 9/2059

(57) ABSTRACT

Provided is a dye-sensitized solar cell, including: an electrode assembly comprising a plurality of photoelectrodes and counter electrodes aligned in a satin weave structure with the photoelectrodes and counter electrodes as warps and wefts, respectively; an electrolyte layer adsorbed to the electrode assembly; and an upper film and a lower film for sealing the electrode assembly at the top and bottom. The dye-sensitized solar cell uses an electrode assembly including as plurality of photoelectrodes having various colored organic dyes adsorbed thereto and counter electrodes. Thus, it is possible for the dye-sensitized solar cell to realize a panchromatic effect by which a broad range of visible rays is absorbed to improve luminance efficiency.

### CROSS-REFERENCE TO RELATED APPLICATIONS

This application claims priority under 35 U.S.C. §119 to Korean Patent Application No. 10-2014-0082970 filed on Jul. 3, 2014 in the Korean Intellectual Property Office, the disclosure of which is incorporated herein by reference in its entirety.

### TECHNICAL FIELD

The following disclosure relates to a textile-based dye-sensitized solar cell and a method for manufacturing the same. Particularly, the following disclosure relates to a textile-based dye-sensitized solar cell realizing a panchromatic effect and a method for manufacturing the same.

### BACKGROUND

The modern society using petroleum as a main energy source is faced with severe problems, such as air pollution and energy depletion. Energy scavenging technology to overcome such problems relates with regeneratable energy that is obtained by using the users' surrounding environment as an energy source, is eco-friendly and requires less recharging of energy. Particularly, solar energy is the representative energy source having the highest energy conversion. Since solar energy was introduced first on 1839, various types of solar cells have been developed to date to use solar energy.

Among such solar cells, the third-generation solar cells, dye-sensitized solar cells (DSSC), using a dye absorbing the light and a nanomaterial for electrodes, convert the light into electric energy with the photosynthesis action of plants as a motif. Although such dye-sensitized solar cells (DSSC) have an energy efficiency corresponding to the half of the energy efficiency of conventional silicone solar cells, they require less than 20% of manufacturing cost, allow production on a thin film or transparent substrate, and are less affected by the incident light, compared to the conventional solar cells. Thus, such dye-sensitive solar cells are advantageous in that they may be used as energy sources for mobile electronic devices requiring charge during migration.

In addition, the dye of dye-sensitized solar cells has a possibility that it may be utilized as a color-based aesthetic factor, which is required additionally for various wearable electronic devices recently.

Recently, various types of flexible dye-sensitized solar cells have been studied to improve their applicability to electronic devices. Particularly, many attentions have been given to fiber type dye-sensitized solar cells (FDSSC) based on fiber-like electrode materials.

However, studies about fiber type dye-sensitized solar cells according to the related art are focused on the development of fiber-based electrodes. Thus, there is an additional need for studies considering balances with various parameters, such as types of electrode nanomaterials, dyes and electrolytes, affecting the shapes of finished cells.

In addition, a cost-efficient and highly effective method for manufacturing fiber type dye-sensitized solar cells (FDSSC) is required for mass production and scale-up of FDSSC considering a broad spectrum of applications of FDSSC.

### REFERENCES

### Patent Document

Patent Document 1: Korean Laid-Open Patent No. 10-2009-0051597

### SUMMARY

An embodiment of the present disclosure is directed to providing a textile-based dye-sensitized solar cell including various colored dyes to realize a panchromatic effect.

Another embodiment of the present disclosure is directed to providing a method for manufacturing a textile-based dye-sensitized solar cell including various colored dyes to realize a panchromatic effect.

In one aspect, there is provided a dye-sensitized solar cell, including: an electrode assembly including a plurality of photoelectrodes and counter electrodes aligned in a satin weave structure with the photoelectrodes and counter electrodes as warps and wefts, respectively; an electrolyte layer adsorbed to the electrode assembly; and an upper film and a lower film for sealing the electrode assembly at the top and bottom thereof.

According to an embodiment, the photoelectrode may include: a central metal wire core material; a conductive layer including nanorods on the surface of the metal wire core material; and an organic dye layer adsorbed to the conductive layer.

According to another embodiment, the conductive layer may include any one selected from zinc oxide (ZnO), titanium dioxide (TiO₂) and cesium carbonate (Cs₂CO₃), or a combination thereof.

According to still another embodiment, the satin weave structure may be any one selected from a 5-harness satin weave structure in which one counter electrode crosses five photoelectrodes, 8-harness satin weave structure in which one counter electrode crosses eight photoelectrodes, 10-harness satin weave structure in which one counter electrode crosses ten photoelectrodes, and 12-harness satin weave structure in which one counter electrode crosses twelve photoelectrodes.

According to still another embodiment, the organic dye layer may be formed of organic dyes for realizing various colors, and may include any one selected from indoline-based organic dyes, coumarine-based organic dyes and Ru-based organic dyes, or a combination thereof.

According to yet another embodiment, the photoelectrodes may have a combination of organic dyes having at least three colors.

In another aspect, there is provided a method for manufacturing a dye-sensitized solar cell, including the steps of: (A) providing a plurality of photoelectrodes and counter electrodes; (B) forming the photoelectrodes and the counter electrodes into a satin weave structure; (C) allowing a polymer electrolyte to be adsorbed to the satin weave electrode assembly; and (D) binding and sealing the satin weave electrode structure having the polymer electrolyte adsorbed thereto by using an upper film and lower film at the top and bottom thereof.

According to an embodiment, step (A) may include: (A-11) washing and providing a plurality of metal wires; (A-12) carrying out a two-step hydrothermal process to form a nanorod-based conductive layer on each of the metal wires; and (A-13) providing a combination of organic dyes having at least three colors and allowing the dyes to be adsorbed to the metal wires each having a conductive layer, in order to provide a plurality of photoelectrodes.

According to another embodiment, step (A) may include: (A-21) washing and providing a plurality of metal wires; and (A-22) dipping the metal wires into a solution in which H₂PtCl₆ is dissolved and removing the metal wires from the solution, followed by calcination, in order to provide a plurality of counter electrodes.

According to still another embodiment, in step (B), the satin weave structure may be any one selected from a 5-harness satin weave structure in which one counter electrode crosses five photoelectrodes, 8-harness satin weave structure in which one counter electrode crosses eight photoelectrodes, 10-harness satin weave structure in which one counter electrode crosses ten photoelectrodes, and 12-harness satin weave structure in which one counter electrode crosses twelve photoelectrodes.

The features and advantages of the present disclosure will be more apparent from the following detailed description taken in conjunction with the accompanying drawings.

Unless otherwise defined, all terms and words used herein have the same meaning as commonly understood by one of ordinary skill in the art. It will be further understood that terms should not be interpreted as having a mining defined in commonly used dictionaries but should be interpreted as having a meaning that is consistent with their meaning in the technical spirit of the present disclosure based on the principle that an inventor can define the concepts of terms suitably in order to illustrate his/her disclosure in the best mode.

The dye-sensitized solar cell according to an embodiment of the present disclosure uses an electrode assembly including a plurality of photoelectrodes having various colored organic dyes adsorbed thereto and counter electrodes. Thus, it can realize a panchromatic effect by which the light within a broad range of visible rays is absorbed to improve luminance efficiency.

The dye-sensitized solar cell according to an embodiment of the present disclosure includes an electrode assembly having a satin weave structure including a plurality of photoelectrodes and counter electrodes. Thus, it can increase the area of photoelectrodes to which light is irradiated and can improve flexibility through a small number of woven points.

### BRIEF DESCRIPTION OF THE DRAWINGS

FIG. 1a is a perspective view illustrating a dye-sensitized solar cell according to an embodiment.

FIG. 1b is a lateral sectional view illustrating a dye-sensitized solar cell according to another embodiment.

FIG. 2 is a flow chart illustrating a method for manufacturing a dye-sensitized solar cell according to an embodiment.

FIG. 3 is an SEM image illustrating the manufacture of a photoelectrode according to an embodiment.

FIG. 4a shows a first electrode assembly form having a 5-harness satin weave structure including five red-colored photoelectrodes and five counter electrodes.

FIG. 4b shows a second electrode assembly form having a 5-harness satin weave structure including five yellow-colored photoelectrodes and five counter electrodes.

FIG. 4c shows a third electrode assembly form having a 5-harness satin weave structure including five pink-colored photoelectrodes and five counter electrodes.

FIG. 4d shows an electrode assembly form having a 5-harness satin weave structure including three red-colored photoelectrodes, one yellow-colored photoelectrode and one pink-colored photoelectrode, and five counter electrodes.

FIG. 4e shows an electrode assembly form having a 5-harness satin weave structure including three yellow-colored photoelectrodes, one red-colored photoelectrode and one pink-colored photoelectrode, and five counter electrodes.

FIG. 4f shows an electrode assembly form having a 5-harness satin weave structure including three pink-colored photoelectrodes, one red-colored photoelectrode and one yellow-colored photoelectrode, and five counter electrodes.

FIG. 5 is a graph of current density vs. voltage in a dye-sensitized solar cell obtained by a weaving process according to an embodiment.

FIG. 6 is a graph of absorptivity vs. wavelength in a dye-sensitized solar cell according to an embodiment.

FIG. 7 is a graph of current density vs. voltage in an dye-sensitized solar cell according to an embodiment.

### DETAILED DESCRIPTION OF EMBODIMENTS

The objects, specific advantages and novel features of the present disclosure will be more apparent from the following detailed description and preferred embodiments taken in conjunction with the accompanying drawings. In the drawings, like reference numerals denote like elements, although they are marked on different drawings. In addition, the use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. In addition, in the description, details of well-known features and techniques may be omitted to avoid unnecessarily obscuring the presented embodiments.

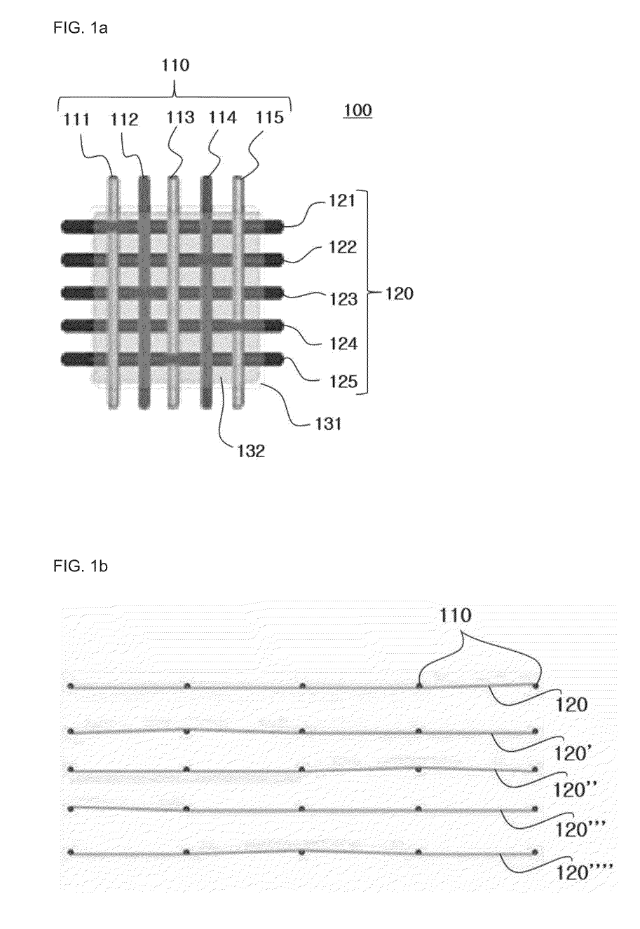

Hereinafter, preferred embodiments of the present disclosure will be explained in detail with reference to the accompanying drawings. FIG. 1a is a perspective view illustrating a dye-sensitized solar cell according to an embodiment, and FIG. 1b is a lateral sectional view illustrating a dye-sensitized solar cell according to another embodiment.

As shown in FIG. 1a, the dye-sensitized solar cell 100 according to an embodiment includes an electrode assembly including a plurality of photoelectrodes 110 and counter electrodes 120 aligned in a satin weave structure with the photoelectrodes and counter electrodes as warps and wefts, respectively, an electrolyte layer (not shown) disposed between the photoelectrodes 110 and the counter electrodes 120, and an upper film 131 and a lower film 132 for sealing the electrode assembly at the top and bottom thereof.

Particularly, the photoelectrodes 110 and the counter electrodes 120 are in the form of wires. More particularly, the photoelectrode 110 includes a central wire core material, a conductive layer including nanorods on the circumferential surface of the wire core material, and an organic dye layer adsorbed to the conductive layer.

Herein, for example, the central wire core material may include a metal, such as copper, nickel, aluminum, iron, chrome or stainless steel, or an alloy of at least two metals selected from the above-mentioned metals.

The conductive layer is one coated and provided on the circumferential surface of the wire core material from nanorods. For example, zinc oxide (ZnO), titanium dioxide (TiO₂) and cesium carbonate (Cs₂CO₃) may be used for the conductive layer. However, it is preferred that the conductive layer is obtained by using zinc oxide (ZnO) in order to form a structure functioning as a path for electron transport, to provide a broad surface area sufficient to maximize the adsorption of organic dyes, and to impart durability against any physical force applied from the external environment.

The organic dye layer is one including various colored organic dyes adsorbed to a conductive layer including nanorods. There is no particular limitation in type of organic dyes and any conventional organic dyes may be used. Preferably, it is possible to use various colored organic dyes having high adsorptivity to the nanorods of the conductive layer. Particularly, it is possible for the organic dye layer to use indoline-based organic dyes, coumarine-based organic dye or Ru-based organic dyes, typically Ru(etc bpy)₂(NCS)₂2 CH₃CN, as the organic dyes for realizing high adsorptivity to the nanorods of the conductive layer and various colors.

On the contrary, the counter electrode 120 includes a central wire core material and platinum (Pt) coating applied on the circumferential surface of the wire core, wherein the wire core may include at least one metal selected from copper, nickel, aluminum, iron, chrome and stainless steel, or an alloy of at least two metals of the above-mentioned metals, like the wire core material of the photoelectrode 110.

As shown in FIG. 1a, the photoelectrodes 110 and the counter electrodes 120 may form an electrode assembly having a satin weave structure in which they have the smallest number of intersecting point as warps and wefts, and the portions of photoelectrodes 110 are exposed mainly to the surface.

Herein, as shown in FIG. 1a, the electrode assembly may have a 5-harness satin weave structure in which one weft crosses per five warps. The woven points of such a 5-harness satin weave structure include a woven point between a first photoelectrode 111 and a first counter electrode 121, a woven point between a second photoelectrode 112 and a third counter electrode 123, a woven point between a third photoelectrode 113 and a fifth counter electrode 125, a woven point between a fourth photoelectrode 114 and a second counter electrode 112, and a woven point between a fifth photoelectrode 115 and a fourth counter electrode 124.

It is a matter of course that the electrode assembly is not limited to the 5-harness satin weave structure as shown in FIG. 1a, and it may have various satin weave structures, including 8-harness satin weave structure in which one counter electrode 120 crosses eight photoelectrodes 110, 10-harness satin weave structure in which one counter electrode 120 crosses ten photoelectrodes 110, and 12-harness satin weave structure in which one counter electrode 120 crosses twelve photoelectrodes 110.

Such a stain weave structure of the electrode assembly has a relatively smaller number of woven points compared to the other textile structures, such as plain weave or twill weave structures, and thus improves flexibility advantageously.

As shown in FIG. 1b, a plurality of such electrode assemblies may be stacked between an upper film 131 and a lower film 132 together with an electrolyte layer (not shown) in a sealed form.

The upper film 131 and the lower film 132 are formed of a flexible and transparent material, and particular examples of such materials include any one selected from the group consisting of polyethylene terephthalate (PET), polyethylene sulfone (PES), polyethylene naphthalate (PEN), polycarbonate (PC), polymethyl methacrylate (PMMA), polyimide (PI), ethylene vinyl acetate (EVA), amorphous polyethylene terephthalate (APET), polypropylene terephthalate (PPT), polyethylene terephthalate glycerol (PETG), polycyclohexylene dimethylene terephthalate (PCTG), modified triacetylcellulose (TAC), cycloolefin polymers (COP), cycloolefin copolymers (COC), dicyclopentadiene polymers (DCPD), cyclopentadiene polymers (CPD), polyarylate (PAR), polyether imide (PEI), polydimethylsiloxane (PDMS), silicone resins, fluororesins and modified epoxy resins, or a combination thereof.

The upper film 131 and the lower film 132 are flexible and may contain a softening agent so that they may have a flexibility corresponding to a modulus of 100-10,000 kg/cm² as determined by the method of ASTM D790. The type and concentration of softening agent may be adjusted suitably.

Particularly, the upper film 131 and the lower film 132 may be formed of a polyethylene terephthalate (PET) material strongly resistant against UV rays. In this case, it is possible to improve washing durability and applicability to smart wear clothes.

The dye-sensitized solar cell 100 according to an embodiment of the present disclosure uses an electrode assembly including a plurality of photoelectrodes 110 having various colored organic dyes adsorbed thereto and counter electrodes 120. Thus, it is possible for the dye-sensitized solar cell to realize a panchromatic effect by which a broad range of visible rays is absorbed to improve luminance efficiency.

In addition, the dye-sensitized solar cell 100 according to an embodiment of the present disclosure includes an electrode assembly of a plurality of photoelectrodes 110 and counter electrodes 120, having a satin weave structure. Thus, it is possible to increase the area of photoelectrodes 110 to which light is irradiated and to improve flexibility through a small number of woven points.

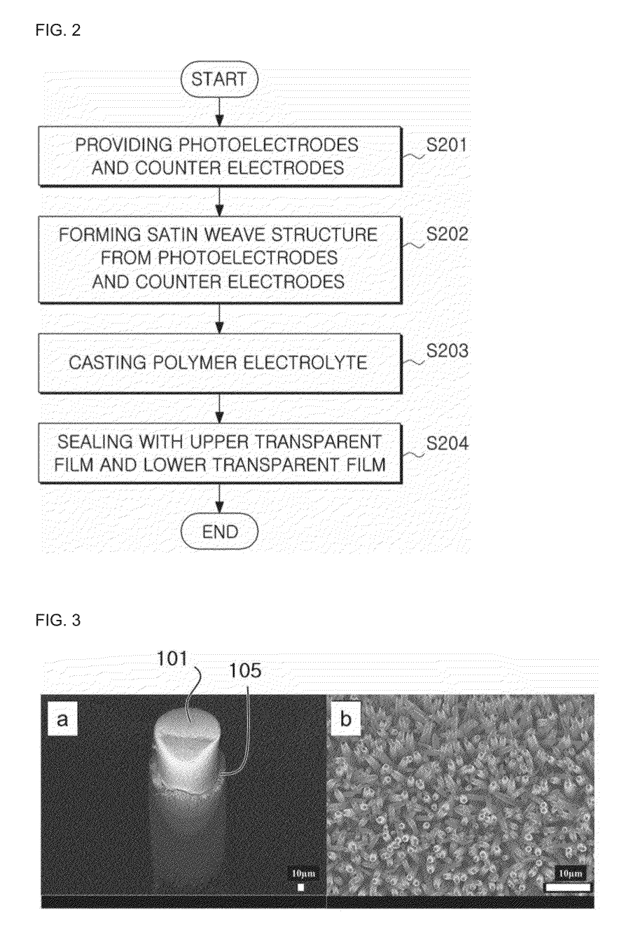

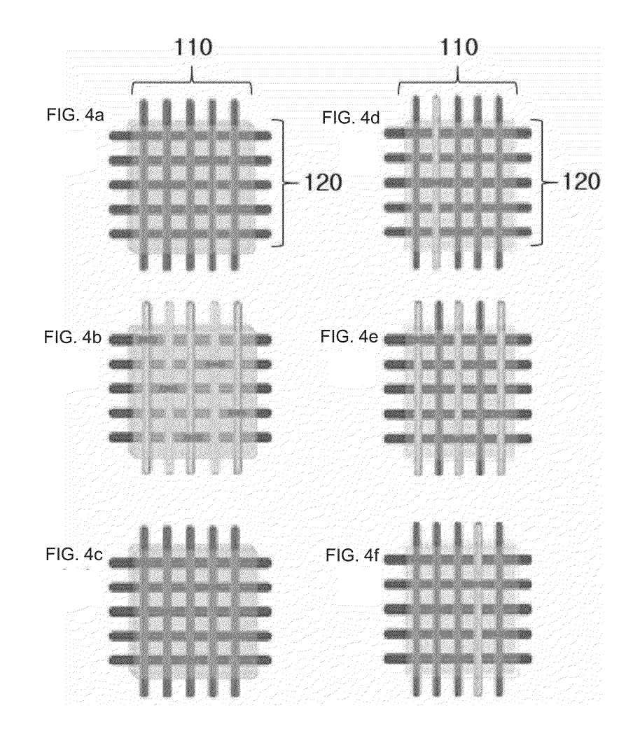

Hereinafter, the method for manufacturing a dye-sensitized solar cell according to an embodiment of the present disclosure will be explained with reference to FIGS. 2-4f. FIG. 2 is a flow chart illustrating a method for manufacturing a dye-sensitized solar cell according to an embodiment. FIG. 3 is an SEM image illustrating the manufacture of a photoelectrode according to an embodiment. FIGS. 4a-4f show perspective views each illustrating a dye-sensitized solar cell using various colored dyes according to an embodiment.

As shown in FIG. 2, in the method for manufacturing a dye-sensitized solar cell according to an embodiment, a plurality of photoelectrodes 110 and counter electrodes 120 are provided (S201).

Particularly, to obtain a plurality of photoelectrodes 110, provided are stainless steel wires 101 having a diameter of 0.1 mm and washed through sonication in 100 ml of isopropyl alcohol (IPA) solution for 30 minutes.

Then, as shown in FIG. 3, a two-step hydrothermal process is carried out to form a conductive layer 105 based on nanorods on the stainless steel wires 101.

Herein, the conductive layer 105 may include zinc oxide (ZnO), titanium dioxide (TiO₂) and cesium carbonate (Cs₂CO₃). However, it is preferred that the conductive layer is formed by using zinc oxide (ZnO) so that it may function as a path for electron transport, have a large surface area to adsorb organic dyes to the highest degree, and have durability against any physical force applied from the external environment.

Particularly, fist, washed stainless steel wires 101 are dipped into a seed solution containing 0.37 ml of diethyl zinc dissolved in 5 ml of tetrahydrofuran (THF) for 30 seconds and removed therefrom, followed by pyrolysis at 450° C. for 30 minutes.

Then, the obtained stainless steel wires 101 are dipped into a growth solution containing 0.050 moles of zinc nitrate hydrate (ZNH), 0.050 moles of HMTA, 0.050 moles of PEI and 0.35 moles of ammonium hydroxide, stored in an oven at 90° C. for 5 minutes, and then removed therefrom. After that, a secondary pyrolysis process is carried out at 450° C. for 30 minutes.

Therefore, as shown in portion (b) of FIG. 3, zinc oxide (ZnO) having a nanorod structure forms a conductive layer 105 like the SEM image of portion (a) of FIG. 3.

Then, the stainless steel wires 101 having a conductive layer 105 are dipped into an organic dye solution so that a dye may be adsorbed thereto. Herein, the organic dye may include an indoline-based organic dye, coumarine-based organic dye or Ru-based organic dye.

For example, ten stainless steel wires 101 having a conductive layer 105 are dipped into the three types of indoline-based organic dyes, D102 (C₃₇H₃₀N₂O₃S₂), D131 (C₃₅H₂₈N₂O₂) and D149 (C₄₂H₃₅N₃O₄S₃), separately, and then stored in an oven at 65° C. so that each dye may be adsorbed to the wires. To optimize the adsorption amount, the three types of dyes may be subjected to an optimized adsorption time of 90 minutes, 120 minutes and 90 minutes, respectively.

On the contrary, to obtain counter electrodes 120, stainless steel wires 101 having a diameter of 0.1 mm and washed through sonication in 100 ml of IPA solution for 30 minutes are dipped into a solution in which 0.35 g of H₂PtCl₆ is dissolved, and then is removed therefrom, followed by calcination at 450° C. for 30 minutes.

The provided photoelectrodes 110 and counter electrodes 120 are formed into a satin weave structure by using a handloom (S202).

Particularly, a plurality of photoelectrodes 110 having various colored organic dyes adsorbed thereto and counter electrodes 120 may be formed into an electrode assembly having a 5-harness satin weave structure by using a handloom, as shown in FIG. 4.

Herein, the electrode assembly may be provided in any one form selected from: a first electrode assembly form having a 5-harness satin weave structure including five red-colored photoelectrodes 110 and five counter electrodes 120 (portion (a) in FIG. 4); a second electrode assembly form having a 5-harness satin weave structure including five yellow-colored photoelectrodes 110 and five counter electrodes 120 (portion (b) in FIG. 4); a third electrode assembly form having a 5-harness satin weave structure including five pink-colored photoelectrodes 110 and five counter electrodes 120 (portion (c) in FIG. 4); a fourth electrode assembly form having a 5-harness satin weave structure including three red-colored photoelectrodes, one yellow-colored photoelectrode and one pink-colored photoelectrode 110, and five counter electrodes 120 (portion (d) in FIG. 4); a fifth electrode assembly form having a 5-harness satin weave structure including three yellow-colored photoelectrodes, one red-colored photoelectrode and one pink-colored photoelectrode 110, and five counter electrodes 120 (portion (e) in FIG. 4); and a sixth electrode assembly form having a 5-harness satin weave structure including three pink-colored photoelectrodes, one red-colored photoelectrode and one yellow-colored photoelectrode 110, and five counter electrodes 120 (portion (f) in FIG. 4).

It is a matter of course that the electrode assembly is not limited to the 5-harness satin-weave structure as shown in FIG. 4, and it may have various satin weave structures, including a 8-harness satin weave structure in which one counter electrode 120 crosses eight photoelectrodes 110, 10-harness satin weave structure in which one counter electrode 120 crosses ten photoelectrodes 110, and 12-harness satin weave structure in which one counter electrode 120 crosses twelve photoelectrodes 110.

After forming the electrode assembly, a polymer electrolyte is subjected to casting onto the electrode assembly so that it may be adsorbed thereto (S203).

For example, the polymer electrolyte adsorbed to the electrode assembly is a PVC-g-POEM branched polymer material represented by the following Chemical Formula 1. The PVC-g-POEM branched polymer material is obtained by mixing tetrahydrofuran in which PVC-g-POEM polymer prepared by an atomic transfer radical polymerization (ATRP) process is dissolved with acetonitrile containing MPII, LI and I₂ to provide a ratio of PVC:POEM of 20:80 (wt %).

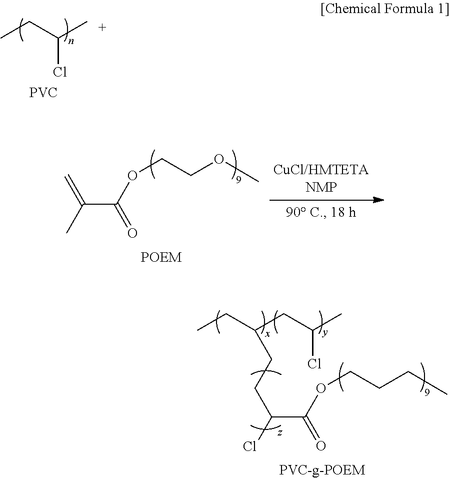

Then, the electrode assembly to which such a polymer electrolyte is adsorbed is subjected to binding and sealing through a hot pressing process at the top and bottom by using a flexible and transparent upper film and lower film (S204).

Herein, the upper film 131 and the lower film 132 include a soft and transparent resin material as mentioned above. For example, the films may include a soft resin having a modulus of 100-10,000 kg/cm² as determined by the method of ASTM D790.

The obtained dye-sensitized solar cell according to an embodiment of the present disclosure has a satin weave-structured electrode assembly including a plurality of photoelectrodes 110 having various colored organic dyes adsorbed thereto and counter electrodes 120. Thus, it is possible to realize a panchromatic effect by which a broad range of visible rays is absorbed to improve luminance efficiency.

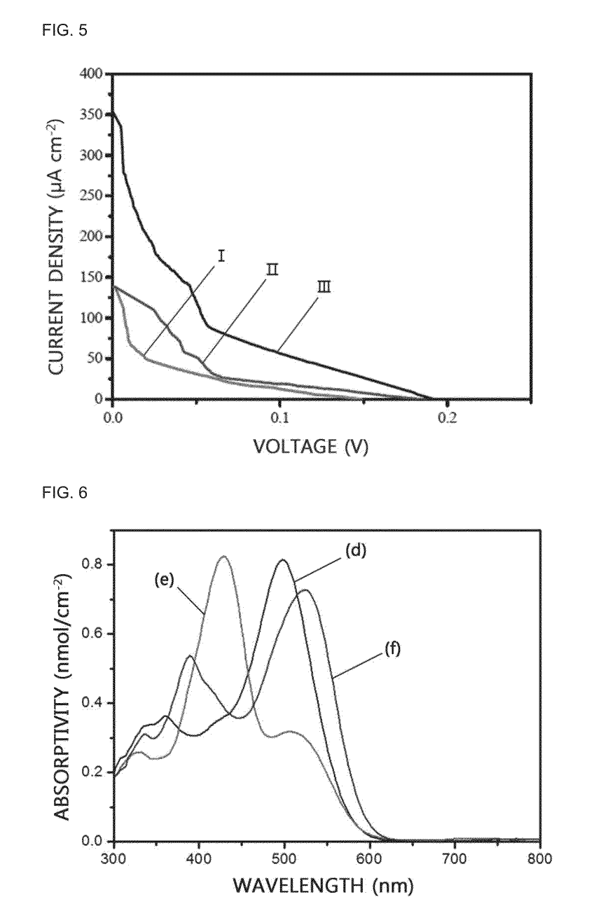

In other words, as shown in FIG. 5, when determined from the graph of current density vs. open voltage in (I) a dye-sensitized solar cell including an electrode assembly having a plain weave structure of a plurality of photoelectrodes 110 and counter electrodes 120, (II) a dye-sensitized solar cell including an electrode assembly having a twill weave structure of a plurality of photoelectrodes 110 and counter electrodes 120, and (III) a dye-sensitized solar cell including an electrode assembly having a satin weave structure of a plurality of photoelectrodes 110 and counter electrodes, the dye-sensitized solar cell including an electrode assembly having a satin weave structure has a higher open voltage and higher current density, compared to the dye-sensitized solar cells (I) and (II).

In addition, it can be seen that the electrode assembly structures having three types of colors, i.e., the electrode assembly structures (d), (e) and (f), among the various types of electrode assemblies as shown in FIG. 4, provide light absorptivity over a broader range of visible rays, compared to the structures having a single color, as shown in the graph of light absorptivity vs. wavelength in FIG. 6.

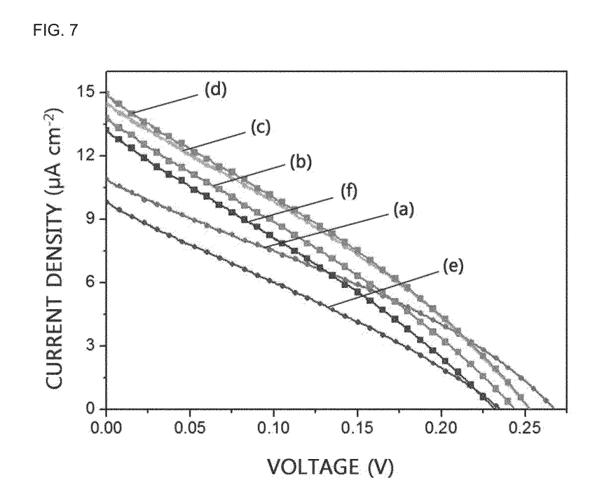

Further, after determining the open voltage and current density for each of the six electrode assembly structures as shown in FIG. 4, the multi-colored dye-sensitized solar cells provide a higher current density value and efficiency compared to the dye-sensitized solar cells having a single color, as shown in FIG. 7.

In other words, as shown in FIG. 7, the efficiency of current density vs. open voltage in each of the six electrode assembly structures as shown in FIG. 4, the multi-colored dye-sensitized solar cells having a combination of three different colors show a higher value compared to the dye-sensitized solar cells having a single color, in the order of (d)>(c)>(b)>(a)>(f)>(e).

As can be seen from the foregoing, the dye-sensitized solar cells including an electrode assembly having three different colored organic dyes, among the dye-sensitized solar cells according to the embodiments of the present disclosure, provide a panchromatic effect by which a relatively broader range of visible rays is absorbed to improve the efficiency of solar cells.

While the present disclosure has been described with respect to the specific embodiments, it will be apparent to those skilled in the art that the above embodiments are for illustrative purposes only and not intended to limit the scope of the present disclosure.

In addition, it will be apparent to those skilled in the art that various changes and modifications may be made without departing from the spirit and scope of the disclosure as defined in the following claims.

[Detailed Description of Main Elements]

| | |
|---|---|
| 100: dye-sensitized solar cell | 101: wire |

| | |
|---|---|
| 105: conductive layer | 110: photoelectrode |

| | |
|---|---|
| 111: first photoelectrode | 112: second photoelectrode |
| 113: third photoelectrode | 114: fourth photoelectrode |
| 115: fifth photoelectrode | 120: counter electrode |

| | |
|---|---|
| 121: first counter electrode | 122: second counter electrode |
| 123: third counter electrode | 124: fourth counter electrode |
| 125: fifth counter electrode | 131: upper film |

132: lower film

What is claimed is:

1. A dye-sensitized solar cell, comprising:
an electrode assembly comprising a plurality of photoelectrodes and counter electrodes aligned in a satin weave structure with the photoelectrodes and counter electrodes as warps and wefts, respectively;
an electrolyte layer adsorbed to the electrode assembly; and
an upper film and a lower film for sealing the electrode assembly at the top and bottom thereof.

2. The dye-sensitized solar cell according to claim 1, wherein the photoelectrode comprises:
a central metal wire core material;
a conductive layer comprising nanorods on the surface of the metal wire core material; and
an organic dye layer adsorbed to the conductive layer.

3. The dye-sensitized solar cell according to claim 2, wherein the conductive layer comprises any one selected from zinc oxide (ZnO), titanium dioxide (TiO₂) and cesium carbonate (Cs₂CO₃), or a combination thereof.

4. The dye-sensitized solar cell according to claim 1, wherein the satin weave structure is any one selected from a 5-harness satin weave structure in which one counter electrode crosses five photoelectrodes, 8-harness satin weave structure in which one counter electrode crosses eight photoelectrodes, 10-harness satin weave structure in which one counter electrode crosses ten photoelectrodes, and 12-harness satin weave structure in which one counter electrode crosses twelve photoelectrodes.

5. The dye-sensitized solar cell according to claim 2, wherein the organic dye layer comprises organic dyes for realizing various colors, and contains any one selected from indoline-based organic dyes, coumarine-based organic dyes and Ru-based organic dyes, or a combination thereof.

6. The dye-sensitized solar cell according to claim 2, wherein the photoelectrodes have a combination of organic dyes having at least three colors.

7. A method for manufacturing a dye-sensitized solar cell, comprising the steps of:
(A) providing a plurality of photoelectrodes and counter electrodes;
(B) forming the photoelectrodes and the counter electrodes into a satin weave structure;
(C) allowing a polymer electrolyte to be adsorbed to the satin weave electrode assembly; and
(D) binding and sealing the satin weave electrode structure having the polymer electrolyte adsorbed thereto by using an upper film and lower film at the top and bottom thereof.

8. The method for manufacturing a dye-sensitized solar cell according to claim 7, wherein step (A) comprises:
(A-11) washing and providing a plurality of metal wires;
(A-12) carrying out a two-step hydrothermal process to form a nanorod-based conductive layer on each of the metal wires; and
(A-13) providing a combination of organic dyes having at least three colors and allowing the dyes to be adsorbed to the metal wires each having a conductive layer, in order to provide a plurality of photoelectrodes.

9. The method for manufacturing a dye-sensitized solar cell according to claim 7, wherein step (A) comprises:
(A-21) washing and providing a plurality of metal wires; and
(A-22) dipping the metal wires into a solution in which H₂PtCl₈ is dissolved and removing the metal wires from the solution, followed by calcination, in order to provide a plurality of counter electrodes.

10. The method for manufacturing a dye-sensitized solar cell according to claim 7, in step (B), the satin weave structure is any one selected from a 5-harness satin weave structure in which one counter electrode crosses five photoelectrodes, 8-harness satin weave structure in which one counter electrode crosses eight photoelectrodes, 10-harness satin weave structure in which one counter electrode crosses ten photoelectrodes, and 12-harness satin weave structure in which one counter electrode crosses twelve photoelectrodes.
